(19) United States
(12) Patent Application Publication
(10) Pub. No.: US 2024/0412267 A1
(43) Pub. Date: Dec. 12, 2024

(54) METHODS AND SYSTEMS FOR SENDING INVOICES WITH OR AS A MEDIA MESSAGE

(71) Applicant: DICOPAY AB, STOCKHOLM (SE)

(72) Inventor: Fredrik Gustaf Krafft, Nacka (SE)

(73) Assignee: DICOPAY AB, STOCKHOLM (SE)

(21) Appl. No.: 18/698,147

(22) PCT Filed: Oct. 4, 2022
(86) PCT No.: PCT/IB2022/059485

§ 371 Date: Apr. 3, 2024

Related U.S. Application Data
(60) Provisional application No. 63/262,084, filed on Oct. 4, 2021.

(51) Int. Cl. G06Q 30/04; G06Q 10/107

(52) U.S. Cl. CPC G06Q 30/04; G06Q 10/107

(57) ABSTRACT

Systems and methods for transmitting and receiving a personalized request for funds to a receiving party are disclosed herein. The disclosed system is capable of creating an invoice in a communication platform, uploading a media message to the communication platform, sending the request for funds and the media message to the receiving party in a single communication using the communication platform, receiving the single communication, and viewing the request for funds and the media message.

### CROSS-REFERENCE TO RELATED APPLICATION

The present application claims priority to U.S. Provisional Patent Application Ser. No. 63/262,084, titled METHODS AND SYSTEMS FOR SENDING INVOICES WITH OR AS A MEDIA MESSAGE, filed Oct. 4, 2021, the disclosure of which is incorporated by reference in its entirety herein.

### SUMMARY

In one general aspect, systems and methods for transmitting and receiving a personalized request for funds to a receiving party are disclosed herein. The disclosed systems are capable of creating an invoice in a communication platform, uploading a media message to the communication platform, sending the request for funds and the media message to the receiving party in a single communication using the communication platform, receiving the single communication, and viewing the request for funds and the media message.

In another aspect, systems and methods for transmitting and receiving a personalized invoice to a receiving party are disclosed herein. The disclosed systems are capable of creating an invoice in an application, recording a media message in the application, and sending the invoice and the media message to the receiving party in a single communication using the application. The system supports receiving the single communication and viewing the invoice and the media message.

In another aspect, systems and methods for transmitting a personalized invoice to a receiving party are disclosed herein. The disclosed systems are capable of creating a request for funds in an application, recording a media message in the application, wherein the media message comprises details relating to status of a particular project, and sending the media message to the receiving party as a single communication using the application.

### BRIEF DESCRIPTION OF THE DRAWINGS

Various features of the embodiments described herein are set forth with particularity in the appended claims. The various embodiments, however, both as to organization and methods of operation, together with advantages thereof, may be understood in accordance with the following description taken in conjunction with the accompanying drawings as follows:

FIG. 1 is a depiction of a merchant interface of a system capable of transmitting a request for funds along with a media message according to at least one aspect of the disclosure;

FIG. 2 is a depiction of the merchant interface of FIG. 1 as a merchant records the media message according to at least one aspect of the disclosure;

FIG. 3 is a depiction of the merchant interface of FIG. 1 as a merchant enters recipient information according to at least one aspect of the disclosure;

FIG. 4 is a depiction of the merchant interface of FIG. 1 prompting a merchant to send the request for funds to a recipient according to at least one aspect of the disclosure;

FIG. 5 is a depiction of a recipient interface when a recipient receives a request for funds delivered through a texting application according to at least one aspect of the disclosure; and

FIG. 6 is a depiction of the recipient interface of FIG. 5 after the recipient clicks on an embedded link within the request for funds according to at least one aspect of the disclosure.

### DETAILED DESCRIPTION

At some point during the performance of a service or sale or a product, a vendor typically issues an invoice to a customer for payment. In other instances, a person may send out a request for money to garner funds for an upcoming project and/or company. Such invoices and/or requests for funds oftentimes are in the form of textual descriptions that briefly detail the work completed, ordered, and/or envisioned followed by the associated costs. A reader of the invoice must then contemplate what work was expected to be performed, whether the work was actually performed, and/or whether the work was performed to an acceptable degree. Similarly, a prospective investor must analyze the textual description of the future work to determine a current state of the project and/or whether to fund the future of the project. Furthermore, textual requests for funds come across as generic and impersonal. There is a need for consumers and/or investors to quickly associate an invoice and/or request for funds to a particular project and/or project status.

Media messages can be used to efficiently provide context and/or communicate a message in an efficient manner that is otherwise difficult, and/or undesirable to convey through text. In various instances, a person may wish to demonstrate a status of a project to current and/or potential investors. Instead of communicating the associated costs with continuing the project through a generic invoice, the person may justify such costs in a detailed and/or personalized video message, for example. In such instances, the person may use such an opportunity to pitch for additional and/or continued funding by investors. Such a video message can convey developer excitement about the project and/or visual status updates that are lost in textual descriptions.

In various instances, the media message can provide a detailed overview of the reason(s) the invoice is being sent. The media message may also be used to accompany and/or provide a quote for a future service and/or good fulfillments. Progress on a particular project that is being funded can be shown.

In use, a merchant, or primary user, initiates the request for funds process by issuing a quote, or invoice, for services and/or goods. Such a quote and/or invoice can be issued through an application, web service, or any other digital service. The digital service can be used on any computer and/or mobile device such as a cell phone, tablet, etc., for example. Stated another way, the invoice can be accessed by any electronic device supportive of the digital service, including a computer and/or handheld electronics such as a cell phone, tablet, and/or a smart watch, for example.

In various instances, the system that is used to send the invoice and/or quote can be fully automated. In such instances, the system comprise a scheduler. The scheduler can trigger the issuance of the invoice and/or quote on a specific date, after an amount of work is completed, and/or an amount of product is delivered. In such instances, the scheduler can be programmed by a user to define certain thresholds indicative of a pre-determined date, a particular amount of completed work, and/or a particular amount of delivered product. In various instances, the system can also create a written offer, quotation, and or invoice directly from a dictation based on the media message. In such instances, the primary user can upload a media message to the system. The system then automatically develops a request for funds based on the contents of the media message and sends to a pre-defined recipient. In various instances, the pre-defined recipient includes existing clients and/or investors.

After initiating the issuance of the invoice, the merchant or the automated system can elect to include a media message, or recording, to be sent along with the quote or invoice. In various instances, the media message itself is the quote or invoice. Stated another way, a separate written quote or invoice is not needed in addition to the media message.

The media message can be reached by the recipient from a link in the communication, a link in the quote or invoice, or displayed together with the quote or invoice. The media message can be in various forms. For example, the media message can be a video, audio recording, and/or any other digital representation. In various instances, for example, the media message can be in the form of an avatar. The message itself can be pre-recorded or the message can be recorded in real time as the invoice is being generated.

Upon receiving the invoice or quote, the buyer, or receiving part, of the quote of invoice has the media message available as a link or the media message is presented directly in the system used for the communication.

The following illustrates a detailed process for sending and receiving a media message as and/or along with an invoice or quote.

To begin, a scenario with a need for a quote or an invoice arises. Such scenarios include, for example, a request for funds from prospective investors, a performed service, and/or a sale of goods. In such instances, a merchant, user, or an automated system of the described system has a need to send a quote or an invoice to a customer or a potential customer.

The merchant, user, or automated system initiates the creation of the desired quote or invoice. The merchant, user, or automated system then creates or attaches a pre-existing media message, or recording, associated with the quote or invoice. In various instances, the media message is the quote or invoice. The media message can have some, or all, of the features and/or properties described in greater detail herein.

The media message can be a pre-recorded video and/or sound file recorded by a primary user. The media message can be a video recording of the party requesting the funds and/or a video recording demonstrating a parameter of the project. For example, the parameter can include a status or state of the funded project. The media message can be a virtual reality (VR) recording. In certain instances, the media message can simply be an audio recording detailing the status of a project and/or the contents of the invoice. The audio recording can be the voice of the primary party and/or an automated voice.

In various instances, the media message can be a digital avatar character. Such an avatar character can be designed and/or created specific to a particular merchant and/or project. The digital avatar character may have an accompanying audio recording, graphical appearances, an ability to speak the words programmed to it, and/or an ability to generate text from what the character is speaking. The digital avatar character may further have deep fake representation, making a visual/graphical and voice representation of a specific person it is programmed to represent. In such instances, the avatar can mimic the movements related to the words spoken by the character. The words can be pre-programmed and/or generated by artificial intelligence (AI). Additional detail regarding deep fake representation can be found at https://en wikipedia.org/wiki/Deepfake, the entire disclosure of which is hereby incorporated by reference. Artificial intelligence (AI) or machine learning programming may provide for the ability to automatically inform or notify the receiving party about the quote or invoice. In such instances, intervention from a user is not needed to develop the invoice and/or send the invoice. Furthermore, in such instances, the character may be able to respond to questions regarding the delivered invoice posed by the receiving party.

The merchant, user, or automated system then includes the media message as a part of and/or attaches the media message to the communication representing the quote or invoice. In other instances, the media message is the only thing being sent to a receiving party if the media message itself is intended to be the invoice or quote. Stated another way, the media message is not accompanied by any additional information such as, for example, a textual representation of the requested funds and/or associated costs.

The receiving party of the quote or invoice can receive the media message, either by a link in the invoice or directly represented on the digital service. For example, if the invoice is received by email, a link to the invoice may be included in body and/or subject line of the email. The receiving party then opens the link, a website associated with the link opens, and the page that opens up shows a text version of the invoice while also having a media message as a video recording, for example. In other instances, the page associated with the website only contains the media message. The website may automatically begin to play the media message. In other instances, the receiving party must hit a play button on the displayed web page.

In various instances, the system can be used to send payment reminders for outstanding invoices and/or reminders for outstanding quotes.

An exemplary use of the described system using an email delivery system is provided herein. At the outset, the merchant is prompted by the system to fill in the details for an invoice. The merchant may access the prompt to fill in the details using an application on his/her phone, for example. In other instances, the merchant may access the prompt to fill in the details using a webpage. Such details may include a description and/or associated price for the work done or proposed. In the same display window and/or form where the merchant filled in his or her invoice specifications, a recording button to start a video recording is present. In various instances, the recording button is solely for an audio recording. In other instances, the merchant can select to record a video and/or audio recording. In any event, the merchant can press this button to record a short message to be sent with or otherwise associated with the invoice.

Prior to sending the invoice, the system will prompt the merchant to input the recipient(s) contact information. The invoice can be sent through various communication streams, including email and/or text message, for example. In this instance, the system is sending the invoice through email. The invoice can be sent in any number of ways, including, for example, through email, text message, and/or through an application. The system may automatically determine the manner of delivery based upon the entered contact information. In various instances, the system can prompt the merchant to select a manner of delivery. In other instances, the system can prompt the merchant to select a standard and/or default method of delivery to be used in all deliveries. In other instances, the system can utilize a particular delivery method for a particular recipient. Such selective particulars can be defined by the merchant prior to creating the invoice. In various instances, the merchant can elect to send the invoice in multiple manners.

The merchant will tap, click, and/or otherwise select a button labeled “send” to send the invoice to the receiving party. In other instances, the button can be labeled “finish,” “complete,” and/or any other suitable name. In other instances, the button configured to send the invoice is not labeled with text at all. Stated another way, the button may be a green button, or any other suitable color.

Upon initiating the transmittal of the invoice, the system is configured to deliver the invoice to the appropriate recipient. The receiving party will receive a notification that a message has been received. The notification is associated with whatever delivery method is used and/or selected. In various instances, the message can include the invoice in addition to a link to the video and/or media message. In other instances, the video and/or media message can be directly embedded within the message. In other instances, a link to and/or the direct media message can be present as the invoice itself. In instances where the media message is embedded within the message as a link, the receiving party clicks to open the link in a web-browser, for example. Upon clicking the link, the media message from the merchant is played.

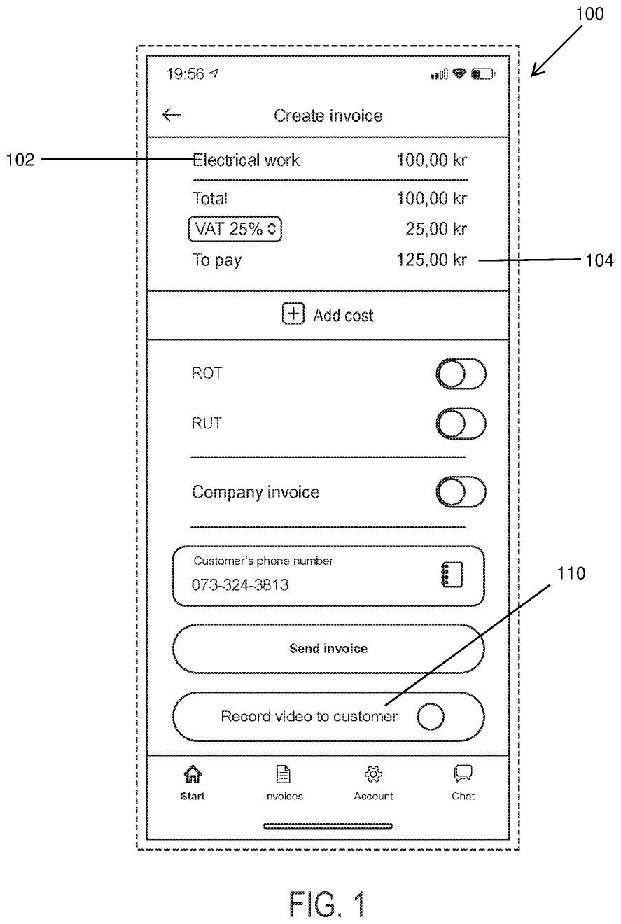

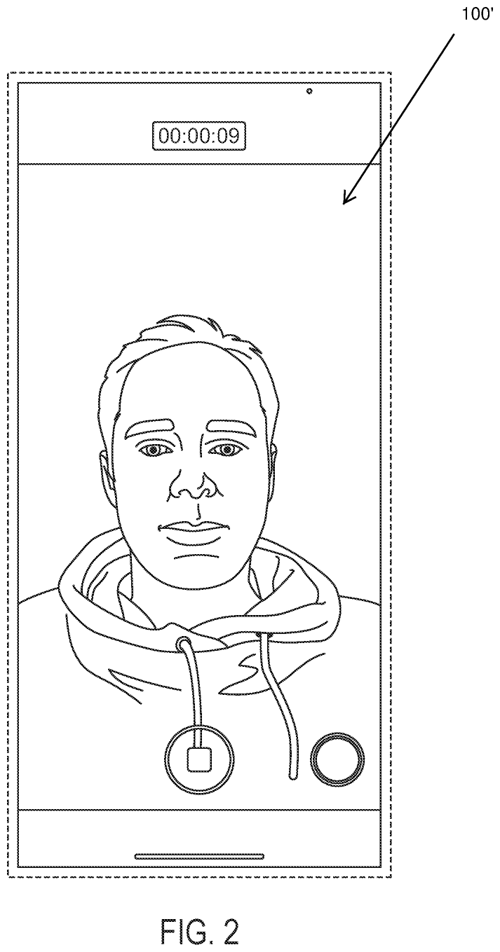

An exemplary use of the described system using a mobile device application is provided herein and shown, for example in FIGS. 1-6. An example of a merchant interface 100 of the system is shown in FIG. 1. At the outset, the merchant is prompted by the system to fill in the details for an invoice. The merchant may access the prompt to fill in the details using an application on his/her phone, for example. In other instances, the merchant may access the prompt to fill in the details using a webpage. Such details may include a description 102 and/or associated price 104 for the work done or proposed. In the same display window and/or form where the merchant filled in his or her invoice specifications, a recording button 110 to start a video recording is present. As shown in FIG. 2, the merchant interface 100′ changes to show the scenario being recorded by the merchant. In various instances, the recording button 110 is solely for an audio recording. In other instances, the merchant can select to record a video and/or audio recording. In any event, the merchant can press this button 110 to record a short message to be sent with or otherwise associated with the invoice.

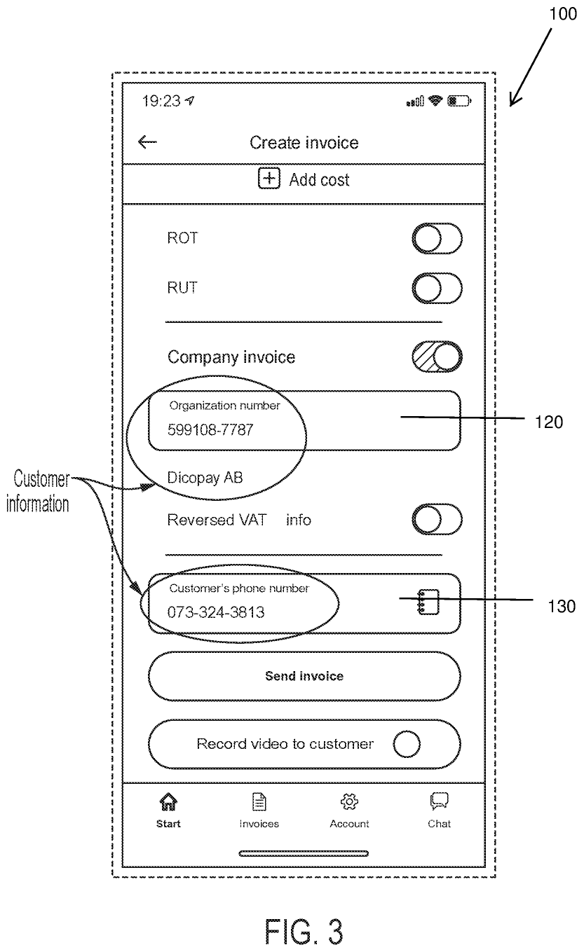

Prior to sending the invoice, the system will prompt the merchant to input the recipient(s) contact information. For example, the receiving party's phone number can be entered. In various instances, an Employer Identification Number (EIN) can be included if the receiving party is a company, for example. As shown in FIG. 3, the merchant interface 100 includes entry fields 120, 130 for the EIN and the recipient's contact information, respectively. The invoice can be sent through various communication streams, including email and/or text message, for example. In this instance, the system is sending the invoice through a mobile device application, such as texting, for example. The invoice can be sent in any number of ways, including, for example, through email, text message, and/or through a separate application. The system may automatically determine the manner of delivery based upon the entered contact information. In various instances, the system can prompt the merchant to select a manner of delivery. In other instances, the system can prompt the merchant to select a standard and/or default method of delivery to be used in all deliveries. In other instances, the system can utilize a particular delivery method for a particular recipient. Such selective particulars can be defined by the merchant prior to creating the invoice. In various instances, the merchant can elect to send the invoice in multiple manners.

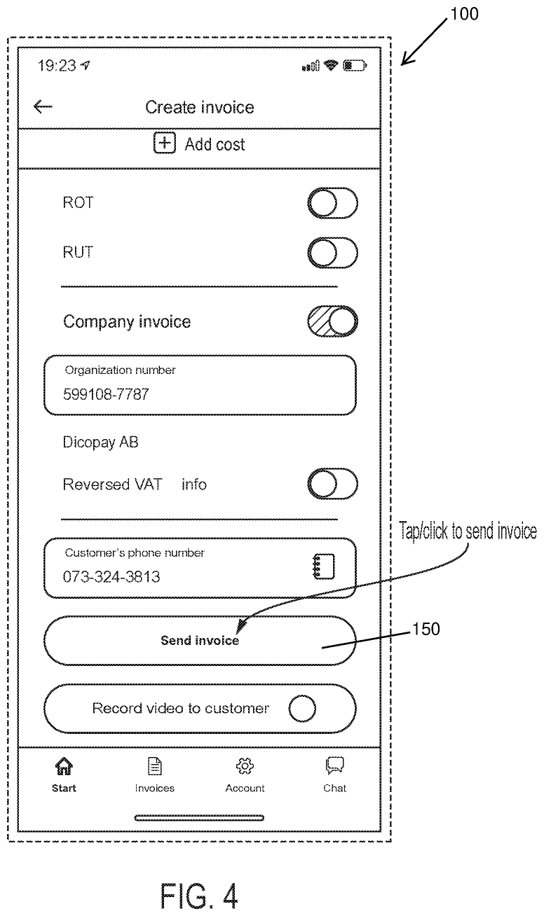

As shown in FIG. 4, the merchant will tap, click, and/or otherwise select a button 150 labeled “send” to send the invoice to the receiving party. The button 150 is present near the bottom of and/or near the end of, for example, the merchant interface 100. In other instances, the button can be labeled “finish,” “complete,” and/or any other suitable name. In other instances, the button configured to send the invoice is not labeled with text at all. Stated another way, the button may be a green button, or any other suitable color.

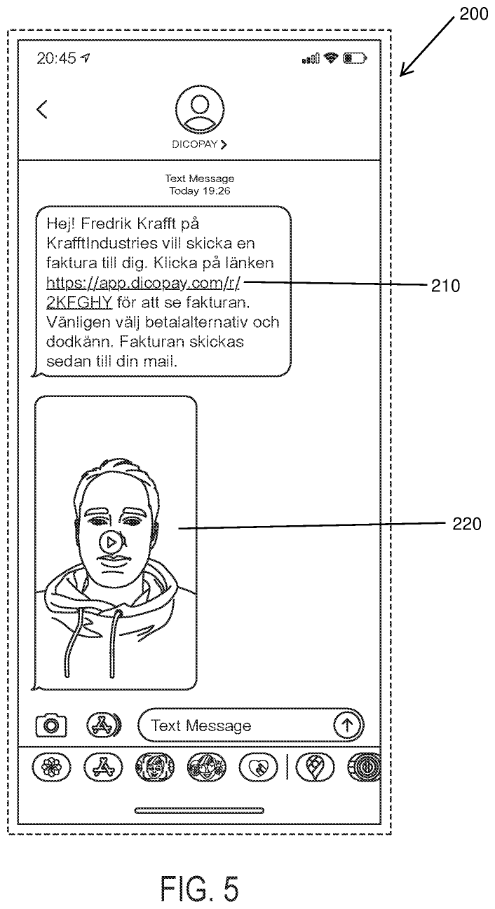

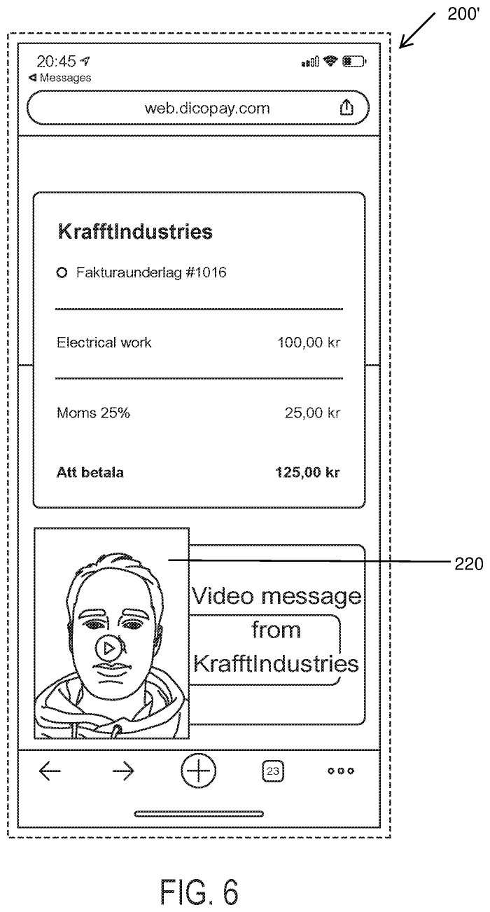

Upon initiating the transmittal of the invoice, the system is configured to deliver the invoice to the appropriate recipient. The receiving party will receive a notification that a message has been received. The notification is associated with whatever delivery method is used and/or selected. In various instances, the notification will prompt the recipient to open the appropriate application on his/her cell phone to access the invoice message. As shown in FIG. 5, the receiving party of the invoice receives a text message shown on a recipient interface 200 with a link 210 to a page for the invoice and the media message that the merchant recorded. In various instances, only the media message 220 may be sent through text message. Stated another way, the recipient does not need to click on the embedded link 210 and, instead, the media message is immediately present within the text message chain. In various instances, the message can include the invoice in addition to a link to the video and/or media message. In other instances, the video and/or media message can be directly embedded within the message. In other instances, a link to and/or the direct media message can be present as the invoice itself. As shown in FIG. 6, in instances where the media message is embedded within the message as a link, the receiving party clicks to open the link in a web-browser, for example. In such instances, the recipient interface 200′ opens the web-browser. Upon clicking the link, the media message 220 from the merchant is played.

While several forms have been illustrated and described, it is not the intention of the applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

For convenience and clarity, spatial terms such as “vertical”, “horizontal”, “up”, and “down” may be used herein with respect to the drawings. However, containers are used in many orientations and positions, and these terms are not intended to be limiting and/or absolute.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method for transmitting and receiving a personalized invoice to a receiving party, the method comprising the steps of:
creating an invoice in an application;
recording a media message in the application;
sending the invoice and the media message to the receiving party in a single communication using the application;
receiving the single communication; and
viewing the invoice and the media message.

2. The method of claim 1, wherein the invoice comprises written details relating to a provided service.

3. The method of claim 1, wherein the method further comprises uploading a pre-recorded media message and attaching the pre-recorded media message to the invoice.

4. The method of claim 1, wherein the media message comprises a video recording.

5. The method of claim 1, wherein the media message comprises an audio recording.

6. The method of claim 1, wherein the single communication is received as an email.

7. The method of claim 6, wherein the invoice is presented in the email as a link to a website.

8. The method of claim 1, wherein the single communication is received by an application on a handheld device.

9. The method of claim 1, wherein the single communication is received as a text message.

10. A method for transmitting a personalized request for funds to a receiving party, the method comprising the steps of:
creating a request for funds in an application;
recording a media message in the application, wherein the media message comprises details relating to status of a particular project; and
sending the media message to the receiving party as a single communication using the application.

11. A method for transmitting and receiving a personalized request for funds to a receiving party, the method comprising the steps of:
creating an invoice in a communication platform;
uploading a media message to the communication platform;
sending the request for funds and the media message to the receiving party in a single communication using the communication platform;
receiving the single communication; and
viewing the request for funds and the media message.

12. The method of claim 11, further comprising recording the media message prior to uploading.

13. The method of claim 12, wherein the media message is recorded in the communication platform.

14. The method of claim 11, wherein the communication platform comprises an application.

15. The method of claim 11, wherein the communication platform comprises an email service.

16. The method of claim 11, wherein the request for funds comprises a text message.
